(19) United States
(12) Patent Application Publication
(10) Pub. No.: US 2024/0220851 A1
(43) Pub. Date: Jul. 4, 2024

(54) SYSTEMS AND METHODS FOR ON-DEVICE TRAINING MACHINE LEARNING MODELS

(71) Applicant: The ADT Security Corporation, Boca Raton, FL (US)

(72) Inventor: Angel Alejandro RODRIGUEZ, Orange Park, FL (US)

(21) Appl. No.: 18/090,944

(22) Filed: Dec. 29, 2022

(51) Int. Cl. G06N 20/00

(52) U.S. Cl. CPC G06N 20/00

(57) ABSTRACT

A user device for a premises security system comprising a plurality of premises devices is provided. The user device is configured with a machine learning model for detecting object types. The user device is configured to receive at least one media file from a media file database associated with the user device, identify at least one dominant object in the at least one media file, receive a feedback indication associated with the at least one dominant object, and train the machine learning model based at least in part on the feedback indication and the at least one media file.

### TECHNICAL FIELD

The present technology is generally related to supporting on-device training of machine learning models in a premises security system.

### BACKGROUND

Existing premises security systems may provide users with basic information or alerts based on detected events, e.g., based on recorded video received from surveillance devices in the premises security system. These events may trigger false alerts. For example, the system may unnecessarily notify a user that motion is detected in the backyard when the user lets her pet dog outside. The user may be “spammed,” or overwhelmed with multiple such false alerts, any time such an event occurs.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a diagram of an example system comprising a premises security system according to principles disclosed herein;

FIG. 2 is a diagram of a control device and a user device in the system according to some embodiments of the present disclosure;

FIG. 3 is a flowchart of an example process in the user device according to some embodiments of the present disclosure; and

FIG. 4 is a flowchart of an example process in a premises security system including a user device and a control device according to some embodiments of the present disclosure.

### DETAILED DESCRIPTION

Embodiments of the present disclosure may facilitate users training and/or updating a machine learning models on their mobile devices that can detect and/or classify objects (e.g., people, pets, things, etc.) that are important and relevant to the users. This model can then be stored, e.g., in a remote computing system, and shared to cameras, doorbells, mobile devices, tablets, etc. This model may facilitate security devices detecting specific objects, providing users with improved and/or heightened security for the events and objects with which they are concerned.

Before describing in detail exemplary embodiments, it is noted that the embodiments may reside in combinations of apparatus components and processing steps related to premises security systems and in particular to supporting on-device training of machine learning models in a premises security system. Accordingly, the system and method components have been represented where appropriate by conventional symbols in the drawings, focusing only on those specific details that facilitate understanding the embodiments of the present disclosure so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes,” “including,” “has,” and “having,” when used herein, specify the presence of stated features, integers, steps, operations, elements, and/or components, but do not preclude the presence or addition of one or more other features, integers, steps, operations, elements, components, and/or groups thereof.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

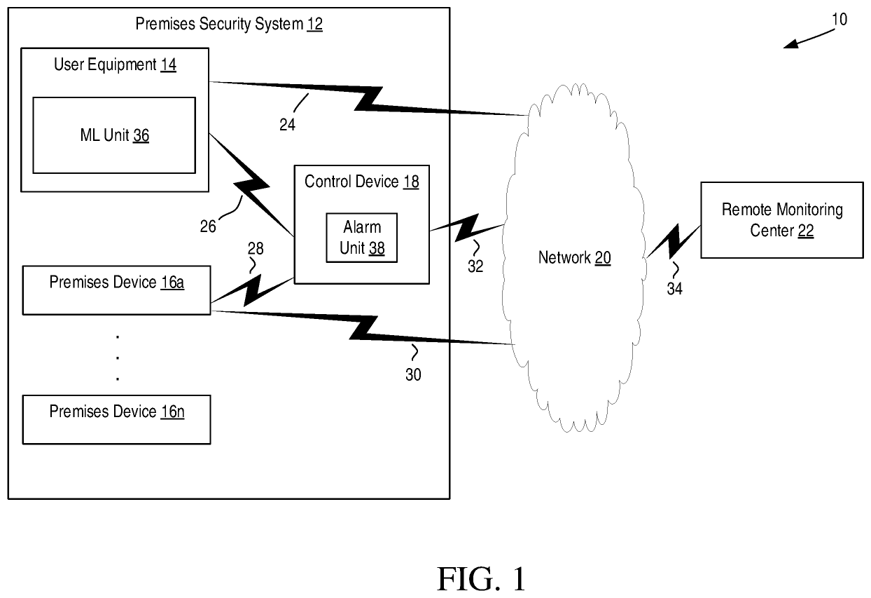

Referring now to the drawing figures in which like reference designators refer to like elements there is shown in FIG. 1 a system designated generally as “10.” System 10 may include premises security system 12 that includes and/or is associated with a user device 14, one or more premises devices 16a to 16n (collectively referred to as “premises device 16”), control device 18. As used herein, “controller” and “control device” are used interchangeably.

System 10 may further include network 20, and a remote monitoring center 22, communicating with each other or with at least one other entity in system 10.

User device 14 may be a user device, such as a user's smartphone, mobile phone, tablet computer, personal computer, laptop computer, etc., which allows a user to communicate with control device 18 and/or one or more premises devices 16. User device 14 may communicate at least with network 20 via communication channel 24 using one or more wired and/or wireless communication protocols. For example, in embodiments where the user device 14 is a mobile phone, the user device 14 may communicate with network 20 (and/or with another device connected to network 20) over the premises' local area network, e.g., a network-based on IEEE 802.11 protocols, over a public land mobile network, etc. User device 14 may communicate at least with control device 18 via communication channel 26 using one or more wired and/or wireless communication protocols. For example, in embodiments where the user device 14 is a mobile phone, the user device 14 may communicate with control device 18 via a Bluetooth based communication link, a Wi-Fi based communication link (e.g., Wi-Fi Direct), a ZigBee based communication link, e.g., a network based on Institute of Electrical and Electronics Engineers (IEEE) 802.15.4 protocols, and/or a Z-wave based communication link, or over the premises' local area network, e.g., a network-based on IEEE 802.11 protocols. Alternatively, user device 14 may indirectly communicate with control device 18 via network 20.

Premises devices 16 may include one or more types of sensors, control devices, image capture devices, audio capture devices, etc. For example, the types of sensors may include various safety related sensors such as motion sensors, fire sensors, carbon monoxide sensors, flooding sensors and contact sensors, among other sensor types. Image capture devices may include a digital camera and/or video camera, among other image capture devices, which may include audio recording capabilities. Premises device 16a may communicate with control device 18 via communication channel 28 using wired and/or wireless communication protocols, including but not limited to the Wi-Fi wireless communication protocol. Premises device 16a may communicate with network 20 via communication channel 30 using wired and/or wireless communication protocols, including but not limited to the Wi-Fi wireless communication protocol. Premises device 16a may communicate with user device 14, control device 18, and/or remote monitoring center 22, e.g., via network 20.

Control device 18 may provide one or more of management functions, monitoring functions, analysis functions, control functions such as power management, premises device management and alarm management/analysis, among other functions for the premises security system 12. In particular, control device 18 may manage one or more life safety and lifestyle features. Life safety features may correspond to security system functions and settings associated with premises conditions that may result in life threatening harm to a person such as carbon monoxide detection and intrusion detection. Lifestyle features may correspond to security system functions and settings associated with video capturing devices and non-life-threatening conditions of the premises such as lighting and thermostat functions. Control device 18 may communicate with network 20 via communication channel 32 using wired and/or wireless communication protocols, including but not limited to the Wi-Fi wireless communication protocol.

In some embodiments, for example, control device 18 may be a touchscreen display panel (e.g., control panel) affixed to a wall in the premises security system 12. In some embodiments, one or more functionalities of control device 18 may be implemented in a user device 14, e.g., where the user device 14 includes an application which provides one or more functionalities of control device 18. In some embodiments, control device 18 may be configured to receive sensor information, image data, audio data, etc., from one or more premises device 16, and may forward at least part of the received information and/or data to another entity in system 10, e.g., user device 14, remote monitoring center 22, etc.

User device 14 may include a machine learning (ML) unit 36 for performing user device 14 functions, such as receiving certain sensor information and/or sensor data from the control device 18 (and/or from one or more premises devices 16) receiving feedback information from the user of user device 14, training and/or updating an ML model based on the received sensor information and/or sensor data and/or feedback information, where the ML model is at least partially stored in the user device 14, and/or where at least a portion of the computation for the training and/or updating of the ML model occurs in the user device 14. The ML unit 36 may be further configured for performing user device 14 functions such as detecting at least one alarm event or at least one object (e.g., person, animal, entity, etc.) based on the received sensor information and/or sensor data using the trained and/or updated ML model.

Control device 18 may include an alarm unit 38 for performing control device 18 functions such as receiving/transmitting certain information and data (e.g., motion sensor data, image data, video data, audio data, etc.) from the premises devices 16, performing certain monitoring, configuration and/or control functions associated with the premises security system 12, and/or functions such as security alert determinations/analysis and functionality as described herein. For example, the control device 18 may be in wired and/or wireless communication with one or more premises device 16. The premises device 16 is configured to trigger and transmit an event signal indicative of detected event to the alarm unit 38. For example, the detected event may be the detection of a user or intruder entering the premises through a door, window, gate, or other physical barrier restricting access or entry to the premises, among other events. Once the signal is received, the alarm unit 38 is configured to perform one or more monitoring, configuration and/or control functions associated with the premises security system 12 based on the event signal. Additionally, in one or more embodiments, the event signal may include sensor data such as audible, visual, and/or tactile information recorded, measured, or otherwise generated by the premises device 16. For example, in embodiments in which the premises device 16 includes an image capture device and/or a microphone, the premises device 16 may capture audio and video of a user or intruder, within a predetermined time window, entering the premises once the user event is detected (e.g., a user/intruder opening a door or window to enter the premises) where the image, video, data, etc., are transmitted to the control device 18 in the event signal.

While control device 18 is illustrated as being a separate device from user device 14 and premises devices 16, in one or more embodiments, control device 18 may be integrated with one or more user device 14 and/or premises devices 16 and/or other entity/device located at one or more premises associated with premises security system 12.

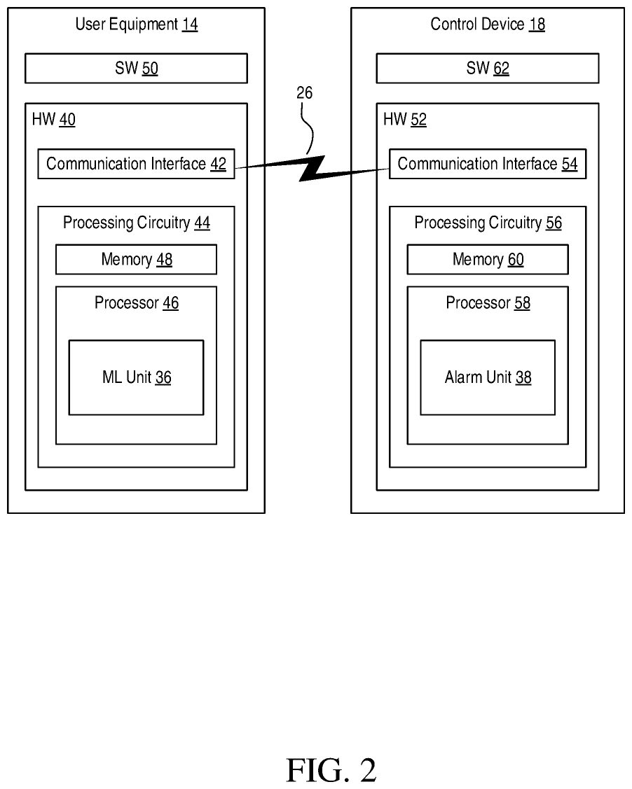

Example implementations, in accordance with one or more embodiments, of user device 14 and control device 18 discussed in the preceding paragraphs will now be described with reference to FIG. 2.

The system 10 includes a user device 14 that includes hardware 40 enabling the user device 14 to communicate with one or more entities in system 10 and to perform one or more functions described herein. The hardware 40 may include a communication interface 42 for setting up and maintaining at least a wired and/or wireless connection (e.g., communication channels 24 and 26, etc.) to one or more entities in system 10 such as remote monitoring center 22, premises devices 16, user device 14, etc.

In the embodiment shown, the hardware 40 of the user device 14 further includes processing circuitry 44. The processing circuitry 44 may include a processor 46 and a memory 48. In particular, in addition to or instead of a processor, such as a central processing unit, and memory, the processing circuitry 44 may comprise integrated circuitry for processing and/or control, e.g., one or more processors, processor cores, field programmable gate arrays (FPGAs), and/or application specific integrated circuits (ASICs) adapted to execute instructions. The processor 46 may be configured to access (e.g., write to and/or read from) the memory 48, which may comprise any kind of volatile and/or nonvolatile memory, e.g., cache and/or buffer memory, random access memory (RAM), read-only memory (ROM), optical memory, and/or erasable programmable read-only memory (EPROM).

Thus, the user device 14 further has software 50 stored internally in, for example, memory 48, or stored in external memory (e.g., database, storage array, network storage device, etc.) accessible by the user device 14 via an external connection. The software 50 may be executable by the processing circuitry 44. The processing circuitry 44 may be configured to control any of the methods and/or processes described herein and/or to cause such methods, and/or processes to be performed, e.g., by user device 14. Processor 46 corresponds to one or more processors 46 for performing user device 14 functions described herein. The memory 48 is configured to store data, programmatic software code and/or other information described herein. In some embodiments, the software 50 may include instructions that, when executed by the processor 46 and/or processing circuitry 44, causes the processor 46 and/or processing circuitry 44 to perform the processes described herein with respect to user device 14. For example, processing circuitry 44 of the user device 14 may include ML unit 36 which is configured to perform one or more user device 14 functions described herein such as with respect to supporting on-device training of machine learning models in a premises security system 12.

The system 10 includes a control device 18 that includes hardware 52 enabling the control device 18 to communicate with one or more entities in system 10 and to perform one or more functions described herein. The hardware 52 may include a communication interface 54 for setting up and maintaining at least a wired and/or wireless connection (e.g., communication channel 26, etc.) to one or more entities in system 10 such as remote monitoring center 22, premises devices 16, user device 14, etc.

In the embodiment shown, the hardware 52 of the control device 18 further includes processing circuitry 56. The processing circuitry 56 may include a processor 58 and a memory 60. In particular, in addition to or instead of a processor, such as a central processing unit, and memory, the processing circuitry 56 may comprise integrated circuitry for processing and/or control, e.g., one or more processors, processor cores, field programmable gate arrays (FPGAs), and/or application specific integrated circuits (ASICs) adapted to execute instructions. The processor 58 may be configured to access (e.g., write to and/or read from) the memory 60, which may comprise any kind of volatile and/or nonvolatile memory, e.g., cache, buffer memory, random access memory (RAM), read-only memory (ROM), optical memory and/or erasable programmable read-only memory (EPROM).

Thus, the control device 18 further has software 62 stored internally in, for example, memory 60, or stored in external memory (e.g., database, storage array, network storage device, etc.) accessible by the control device 18 via an external connection. The software 62 may be executable by the processing circuitry 56. The processing circuitry 56 may be configured to control any of the methods and/or processes described herein and/or to cause such methods, and/or processes to be performed, e.g., by control device 18. Processor 58 corresponds to one or more processors 58 for performing control device 18 functions described herein. The memory 60 is configured to store data, programmatic software code and/or other information described herein. In some embodiments, the software 62 may include instructions that, when executed by the processor 58 and/or processing circuitry 56, causes the processor 58 and/or processing circuitry 56 to perform the processes described herein with respect to control device 18. For example, processing circuitry 56 of the control device 18 may include alarm unit 38 which is configured to perform one or more control device 18 functions described herein such as with respect to implementing and deploying on-device-trained machine learning models in a premises security system.

Although FIGS. 1 and 2 show ML unit 36 and alarm unit 38 as being within a respective processor, this unit may be implemented such that a portion of the unit is stored in a corresponding memory within the processing circuitry. In other words, the unit may be implemented in hardware or in a combination of hardware and software within the processing circuitry.

In some embodiments of the present disclosure, the machine learning model may start with a Deep Neural Network (DNN) architecture that is trained to classify one or more dominant objects, e.g., in a camera frame or image. A “dominant” object may refer to at least one object in a frame (or image, video, etc.), such as a cat, a car, a pedestrian, an open door, a broken window, etc., which is identifiable in the frame, and which may be the largest and/or most significant object in the frame. This model may be further modified to behave as a k-Nearest Neighbor model, e.g., by removing the layers to allow new classifiers to be added. Other ML model types and neural network architectures may be used without deviating from the scope of the present disclosure.

In some embodiments, user device 14 may be a mobile device, for example, an iOS device (e.g., iPhone, iPad, etc.) running an Apple IOS operating system, an Android device running a Google Android operating system, and/or a personal computer running, e.g., Windows 11, MacOS, Linux, etc.

In embodiments where the user device 14 is an iOS device which is configurable with the CoreML library of functions (e.g., a predefined library of one or more ML functions that may be used to generate and/or train an ML model), which may be preconfigured with CoreML as part of iOS), the ML model may be generated by and/or trained and/or updated using CoreML and processing circuitry 44 of user device 14. For example, a user of user device 14 may upload images and labels for corresponding objects using their iOS device, e.g., by selecting photos from a photo library tool or media file database and selecting and/or inputting label text to be associated with each photo or with at least one dominant object identified (e.g., using ML unit 36) within an image/video frame. The media file database may include media generated by at least one premises device 16 (e.g., a surveillance camera in the premises security system 12), and/or may include media files that are not generated by or otherwise associated with the premises security system 12, e.g., videos captured on a user's phone. The user device 14 (e.g., ML unit 36) may perform on-device training to train and/or retrain the model with new data, e.g., using the Core ML library. Similarly, a user device 14 which is an Android devices may use Android libraries and models (e.g., a predefined library of one or more ML functions that may be used to generate and/or train an ML model, such as TensorFlow lite) to perform similar ML model training functionalities.

In some embodiments, at least a portion of the ML model can be deployed (e.g., uploaded to) to a remote server, e.g., of remote monitoring center 22. Remote monitoring center 22 may utilize a converter and/or translator to convert the ML model to another type of model or configuration which may be then forwarded to one or more devices (e.g., control device 18).

In some embodiments, the machine learning model may at least partially be stored in memory 48 of user device 14, e.g., in the form of one more parameters, weights, etc., which may be stored, for example, as a data structure and/or data file.

In some embodiments, a user may create a label (e.g., using a touchscreen display of user device 14 to type in text, select an icon, select a pre-defined text element from a drop down menu, etc.), and may associate the label with a dominant object (e.g., a person, an animal, a thing, etc.), where the object may be identified (but not necessarily labeled) by ML unit 36. For example, ML unit 36 may receive media file (e.g., video, audio, images, etc.) including an image frame from a premises device 16 which is a video camera, may identify a first dominant object (e.g., a person) and a second dominant object (e.g., an animal) in the image frame, but ML unit 36 may not necessarily assign a label to either the first dominant object and/or the second dominant object. In other words, ML unit 36 may recognize that the first object is an object in the environment, and may identify the region or boundaries of the object within the video or image frame, but may be unable to classify it as a person or as a particular person without further training and/or input from a user. The user may be presented (e.g., on a display of user device 14) with the image frame, which may include annotations (e.g., a first rectangular box around the first object and a second rectangular box around the second object) corresponding to the identified objects. The user may be presented with an interface for inputting the labels for each of the first object and the second object, e.g., the user may select “person” for the first object and “animal” for the second object. The user may further refine the labels with more detail. For example, the user may apply a first label such as “known person”, “trusted person”, “unknown person”, “intruder”, etc., for the first object, and a second label such as “pet dog,” “pet cat”, “unknown dog”, “dangerous wildlife”, etc., for the second object. The detailed labels and associated sensor information (e.g., image data for a portion of the image frame corresponding to the bounded area of the first rectangular box) may be input into the ML model by ML unit 36 for training (and/or updating) the ML model. By training the ML model in this manner, it may more accurately identify similar objects (e.g., classified objects) in the future. For instance, a user labels an object in a first image frame as an “intruder”. The ML unit 36 trains and/or updates the ML model with the image frame object and label. In a second image frame, the ML unit 36 may utilize the trained and/or updated ML model to recognize the intruder in the second image frame.

In some embodiments, the user may provide existing images for the ML unit 36 to use as training data for the ML model. For example, a user may upload an image from the user's photo library to the ML unit 36, and may provide the ML unit 36 with a corresponding label for the uploaded image. In some embodiments, the ML unit 36 may receive an image from a premises device 16 (e.g., a surveillance camera providing video comprised of image frames and audio), and present the received image to the user, and request that the user label the image (and/or label one or more objects identified in the image).

In some embodiments, ML unit 36 performs the training of the ML model. In some embodiments and/or scenarios, the training by ML unit 36 may not require any remote processing or data, e.g., even if user device 14 lacks a connection to the internet, ML unit 36 may still be able to train and/or update the ML model. In some embodiments, the ML model may be preconfigured in user device 14, e.g., received from a remote server and/or installed during manufacturing, which may be a default/base ML model, which may be further refined and/or trained and/or updated based on additional data and labels input by user on user device 14. For example, the preconfigured ML model may be pre-trained for recognizing adults, children, animals, weapons, etc., and may use the additional data and labels to improve accuracy and/or to provide additional detail in the detection (e.g., identifying specific individuals by name, identify classified objects, specifying a threat level associated with the person, etc.).

In some embodiments, the ML model may be updated and/or trained by ML unit 36 and the updated and/or trained ML model may be uploaded by user device 14 to a cloud-based server (e.g., remote monitoring center 22) or other device. The ML model may be associated with the user's account with a security service. The ML model may then be deployed (e.g., downloaded) to other devices, e.g., an edge device such as premises device 16, control device 18, another user device 14, etc. The other devices may utilize the machine learning model to detect object types for objects identified in media files (e.g., video surveillance feeds), and/or may further update the machine learning model based on additional media files and/or feedback from users.

For example, control device 18 may receive the ML model updated and/or trained by ML unit 36, which may be received directly from user device 14 or via one or more intermediary devices, e.g., network 20, remote monitoring center 22, a remote and/or cloud-based server, etc.

In some embodiments, the user may configure rules around events, where the events are detected by the ML unit 36 using the ML model. For example, the user, e.g., via a user interface of user device 14 and/or control device 18, may configure rules corresponding to one or more actions for the premises security system 10. For example, the user may configure a particular premises security system 11 alarm to be triggered if an object is identified using the ML model as “intruder” or identifies a person as having a high associated threat level, but to suppress the alarm if the object is identified as “homeowner” or as a person who has a low associated threat level. As another example, the user may configure a particular premises security system 11 alarm to be triggered if the object is identified using the ML model as “neighbor's dog”, but to suppress the alarm if the object is identified as “homeowner's pet dog”. A variety of different associations of alarms and triggering objects may be configured by user and/or may be preconfigured, and may be stored in a rule configuration file, for example, in memory 48 of user device 14 or memory 60 of control device 18.

For example, in some embodiments, a rule configuration file may be received by alarm unit 38 of control device 18. Alarm unit 38 may also receive the ML model updated and/or trained by ML unit 36. Alarm unit 38 may receive one or more premises security surveillance video feeds, images, audio recordings, or sensor data from one or more premises device 16, may utilize the ML model to identify objects in the received premises device 16 data (e.g., objects in one or more image frames of a video feed) and to label or classifies the identified objects, and may associate the labels with the objects and/or received premises device 16 data. Based on the rule configuration file, the alarm unit 38 maps the labels to corresponding alarm events and/or premises security actions, and performs one or more premises security actions (e.g., trigger an alarm, suppress an alarm, send a notification to a user device 14, send a notification to remote monitoring center 22, etc.) based on the mapping.

In some embodiments, a premises device 16 (e.g., a surveillance camera) may include an alarm unit 38, and may further include the ML model updated and/or trained by ML unit 36. The premises device 16 may perform one or more of the above-described functions of control device 18 (e.g., identifying objects, determining object labels, mapping to alarm events and/or premises security actions, etc.).

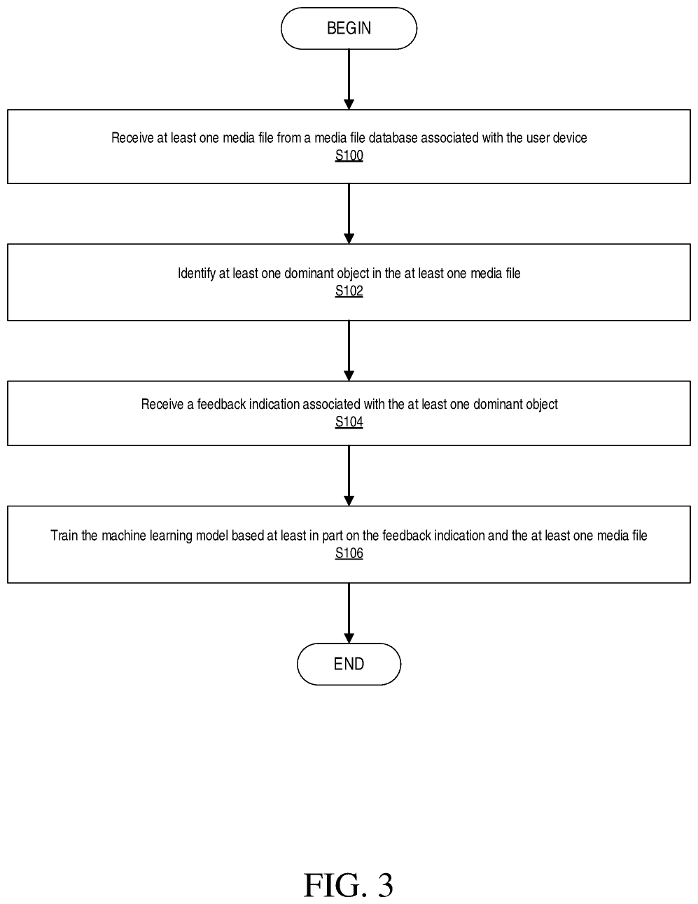

FIG. 3 is a flowchart of an example process in a user device 14 according to one or more embodiments of the present invention. One or more blocks described herein may be performed by one or more elements of user device 14 such as by one or more of processing circuitry 44 (including the ML unit 36), processor 46, etc. User device 14 is configured to communicate with a control device 18 in a premises security system 12. User device 14 is configured to receive (Block S100) at least one media file from a media file database associated with the user device 14. For example, the media file database may be a photo and/or video library stored locally on user device 14 (e.g., in memory 48), and/or may be stored remotely (e.g., on a remote server associated with a user account of the user device 14) and accessible on user device 14. User device 14 is configured to identify (Block S102) at least one dominant object in the at least one media file. For example, in a video frame depicting objects such as an adult person, a child, and a dog, the identified at least one dominant object in the frame may include defining boundaries of regions of the frame corresponding to each object. These regions and/or dominant objects (e.g., identified by boundary boxes) may be presented on a display of the user device 14 for viewing by the user, who may then input (e.g., via a touchscreen interface, voice recognition interface, etc.), information (e.g., labels, classifications, etc.) corresponding to one or more of the identified dominant objects or regions of the frame. User device 14 is configured to receive (Block S104) a feedback indication associated with the at least one dominant object. User device 14 is configured to train (Block S106) the machine learning model based at least in part on the feedback indication and the at least one media file. For example, one or more parameters or weights of the machine learning model may be updated based on the feedback indication and the at least one media file.

In some embodiments, the user device 14 is further configured to determine or modify an alarm configuration comprising a mapping of at least one detected object type to at least one corresponding premises security action, and cause transmission of the alarm configuration and the machine learning model to the control device 18 for performing at least one premises security action based at least in part on the alarm configuration and the machine learning model.

In some embodiments, the user device 14 is further configured to cause transmission of the machine learning model to another user device 14 of the premises security system 12 for further training the machine learning model to generate an updated machine learning model, and responsive to causing transmission of the machine learning model to the other user device 14, receive the updated machine learning model, where the updated machine learning model is based at least in part on additional feedback indications received on the other user device 14. User device 14 is configured to detect at least one object type of at least one additional media file based at least in part on the updated machine learning model.

In some embodiments, the feedback indication includes at least one of an object type label, an accuracy indication, and a threat level indicator. This information may then be used by the machine learning model to improve the accuracy of object type predictions.

In some embodiments, the user device 14 is further configured to receive at least one additional media file from a premises device 16 in the premises security system 12, identify an additional dominant object in the at least one additional media file, detect at least one classified object type of the additional dominant object using the machine learning model, receive at least one additional feedback indication associated with the at least one classified object type, and further train the machine learning model based at least in part on the at least one additional feedback indication and the at least one additional media file.

In some embodiments, the user device 14 is configured to cause transmission of the machine learning model to a remote server 22 for providing on-device object detection for at least one additional device (e.g., another user device 14) associated with a user account of the premises security system 12.

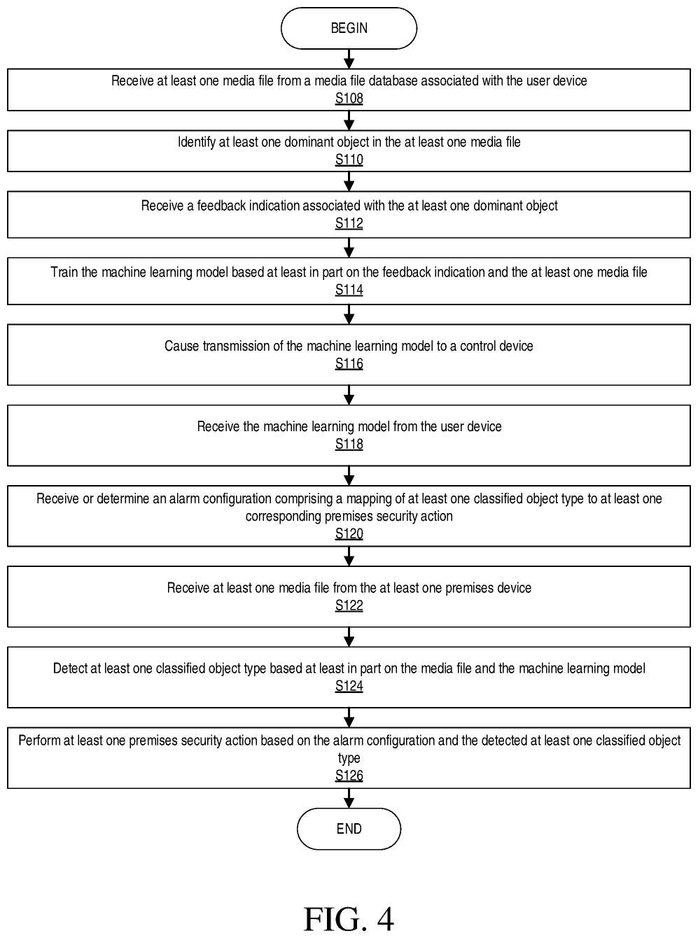

FIG. 4 is a flowchart of an example process in a premises security system 12 including a user device 14, a premises device 16, and a control device 18, according to one or more embodiments. One or more blocks described herein may be performed by one or more elements of user device 14 such as by one or more of processing circuitry 44 (including the ML unit 36), processor 46, etc. One or more blocks described herein may be performed by one or more elements of control device 18 such as by one or more of processing circuitry 56 (including the Alarm unit 38), processor 58, etc. User device 14 is configured to receive (Block S108) at least one media file from a media file database associated with the user device 14. User device 14 is configured to identify (Block S110) at least one dominant object in the at least one media file. User device 14 is configured to receive (Block S112) a feedback indication associated with the at least one dominant object. User device 14 is configured to train (Block S114) the machine learning model based at least in part on the feedback indication and the at least one media file.

User device 14 is configured to cause transmission (Block S116) of the machine learning model to the control device 18. The control device 18 is configured to receive (Block S118) the machine learning model from the user device 14. The control device 18 is configured to receive or determine (Block S120) an alarm configuration comprising a mapping of at least one detected object type to at least one corresponding premises security action. The control device 18 is configured to receive (Block S122) at least one media file from the at least one premises device 16. The control device 18 is configured to detect (Block S124) at least one classified object type based at least in part on the media file and the machine learning model. The control device 18 is configured to perform (Block S126) at least one premises security action based on the alarm configuration and the detected at least one classified object type.

In some embodiments, the control device 18 is further configured to cause transmission of the machine learning model to another user device 14 of the premises security system for further training the machine learning model to generate an updated machine learning model, responsive to causing transmission of the machine learning model to the other user device 14, receive the updated machine learning model, the updated machine learning model being based at least in part on additional feedback indications received on the other user device 14, detect at least one additional classified object type of at least one additional media file based on the updated machine learning model, and perform at least one premises security action based on the at least one additional classified object type and the security configuration.

In some embodiments, the control device 18 is further configured to cause transmission of the machine learning model to a premises device 16 of the premises security system for detecting object types from a locally-stored media file, responsive to causing transmission of the machine learning model to the premises device 16, receive a detection indication corresponding to at least one additional classified object type identified in the locally-stored media file, and perform at least one premises security action based on the at least one additional predicted object type and the security configuration. Locally-stored may refer to the media file being stored in a local memory of premises device 16, e.g., such that the premises device 16 may perform the machine learning model object type prediction on the locally-stored media file without necessarily requiring remote processing of or transmission of the locally-stored media file.

In some embodiments, the feedback indication includes at least one of an object type label, an accuracy indication, and a threat level indicator.

In some embodiments, the control device 18 is further configured to determine or modify the security configuration based least in part based on the threat level indication associated with at least one classified object type.

In some embodiments, the control device 18 is further configured to receive at least one additional media file from a premises device 16 in the premises security system, identify an additional dominant object in the at least one additional media file, detect at least one additional classified object type of the additional dominant object using the machine learning model, receive, from at least one user device 14 in the premises security system, at least one additional feedback indication associated with the at least one additional classified object type, and further train the machine learning model based on the at least one additional feedback indication.

In some embodiments, the control device 18 is further configured to cause transmission of the machine learning model to a remote server for providing on-device objection detection for at least one additional device associated with a user account of the premises security system.

The concepts described herein may be embodied as methods, data processing systems, computer program products and/or computer storage media storing executable computer programs. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. All embodiments can be combined in any way and/or combination, though all such ways and combinations may not have been explicitly described herein because it would be unduly repetitious and obfuscating.

It will be appreciated by persons skilled in the art that the present embodiments are not limited to what has been particularly shown and described herein above. In addition, unless mention was made above to the contrary, all of the accompanying drawings are not to scale. A variety of modifications and variations are possible in light of the above teachings without departing from the scope of the following claims.

What is claimed:

1. A user device for a premises security system comprising a plurality of premises devices, the user device being configured with a machine learning model for detecting object types, the user device comprising processing circuitry being configured to:
receive at least one media file from a media file database associated with the user device;
identify at least one dominant object in the at least one media file;
receive a feedback indication associated with the at least one dominant object; and
train the machine learning model based at least in part on the feedback indication and the at least one media file.

2. The user device of claim 1, wherein the processing circuitry is further configured to:
determine or modify an alarm configuration comprising a mapping of at least one detected object type to at least one corresponding premises security action; and
cause transmission of the alarm configuration and the machine learning model to the control device for performing at least one premises security action based at least in part on the alarm configuration and the machine learning model.

3. The user device of claim 1, wherein the processing circuitry is further configured to:
cause transmission of the machine learning model to another user device of the premises security system for further training the machine learning model to generate an updated machine learning model;
responsive to causing transmission of the machine learning model to the other user device, receive the updated machine learning model, the updated machine learning model being based at least in part on additional feedback indications received on the other user device; and
detect at least one object type of at least one additional media file based at least in part on the updated machine learning model.

4. The user device of claim 1, wherein the feedback indication comprises at least one of:
an object type label;
an accuracy indication; and
a threat level indicator.

5. The user device of claim 1, wherein the processing circuitry is further configured to:
receive at least one additional media file from a premises device in the premises security system;
identify an additional dominant object in the at least one additional media file;
detect at least one classified object type of the additional dominant object using the machine learning model;
receive at least one additional feedback indication associated with the at least one classified object type; and
further train the machine learning model based at least in part on the at least one additional feedback indication and the at least one additional media file.

6. The user device of claim 1, wherein the processing circuitry is further configured to cause transmission of the machine learning model to a remote server for providing on-device object detection for at least one additional device associated with a user account of the premises security system.

7. A premises security system comprising at least one premises device for monitoring a premises, the premises security system comprising:
a user device configured with a machine learning model for detecting object types, the user device comprising processing circuitry configured to:
receive at least one media file from a media file database associated with the user device;
identify at least one dominant object in the at least one media file;
receive a feedback indication associated with the at least one dominant object;
train the machine learning model based at least in part on the feedback indication and the at least one media file; and
cause transmission of the machine learning model to a control device; and
the control device comprising processing circuitry, the processing circuitry being configured to:
receive the machine learning model from the user device;
receive or determine an alarm configuration comprising a mapping of at least one classified object type to at least one corresponding premises security action;
receive at least one media file from the at least one premises device;
detect at least one classified object type based at least in part on the media file and the machine learning model; and
perform at least one premises security action based on the alarm configuration and the detected at least one classified object type.

8. The premises security system of claim 7, wherein the processing circuitry of the control device is further configured to:
cause transmission of the machine learning model to another user device of the premises security system for further training the machine learning model to generate an updated machine learning model;
responsive to causing transmission of the machine learning model to the other user device, receive the updated machine learning model, the updated machine learning model being based at least in part on additional feedback indications received on the other user device;
detect at least one additional classified object type of at least one additional media file based on the updated machine learning model; and
perform at least one premises security action based on the at least one additional classified object type and the security configuration.

9. The premises security system of claim 7, wherein the processing circuitry of the control device is further configured to:
cause transmission of the machine learning model to a premises device of the premises security system for detecting object types from a locally-stored media file;
responsive to causing transmission of the machine learning model to the premises device, receive a detection indication corresponding to at least one additional classified object type identified in the locally-stored media file; and
perform at least one premises security action based on the at least one additional classified object type and the security configuration.

10. The premises security system of claim 7, wherein the feedback indication comprises at least one of:
an object type label;
an accuracy indication; and
a threat level indicator.

11. The premises security system of claim 10, wherein the processing circuitry of the control device is further configured to determine or modify the security configuration based least in part based on the threat level indication associated with at least one classified object type.

12. The premises security system of claim 7, wherein the processing circuitry of the control device is further configured to:
receive at least one additional media file from a premises device in the premises security system;
identify an additional dominant object in the at least one additional media file;
detect at least one additional classified object type of the additional dominant object using the machine learning model;
receive, from at least one user device in the premises security system, at least one additional feedback indication associated with the at least one additional classified object type; and
further train the machine learning model based on the at least one additional feedback indication.

13. The premises security system of claim 7, wherein the processing circuitry of the control device is further configured to cause transmission of the machine learning model to a remote server for providing on-device object detection for at least one additional device associated with a user account of the premises security system.

14. A method implemented by a premises security system comprising at least one premises device for monitoring a premises, a user device configured with a machine learning model for detecting object types, and a control device, the method comprising:
receiving, at the user device, at least one media file from a media file database associated with the user device;
identifying at least one dominant object in the at least one media file;
receiving, at the user device, a feedback indication associated with the at least one dominant object;
training the machine learning model based at least in part on the feedback indication and the at least one media file;
receiving, at the control device, the machine learning model from the user device;
determining an alarm configuration comprising a mapping of at least one classified object type to at least one corresponding premises security action;
receiving, at the control device, at least one media file from the at least one premises device;
detecting at least one classified object type based at least in part on the media file and the machine learning model; and
performing at least one premises security action based on the alarm configuration and the detected at least one classified object type.

15. The method of claim 14, wherein the method further comprises:
causing transmission of the machine learning model to another user device of the premises security system for further training the machine learning model to generate an updated machine learning model;
responsive to causing transmission of the machine learning model to the other user device, receiving, at the control device, the updated machine learning model, the updated machine learning model being based at least in part on additional feedback indications received on the other user device;
detecting at least one additional classified object type of at least one additional media file based on the updated machine learning model; and
performing at least one premises security action based on the at least one additional classified object type and the security configuration.

16. The method of claim 14, wherein the method further comprises:
causing transmission of the machine learning model to a premises device of the premises security system for detecting object types from a locally-stored media file;
responsive to causing transmission of the machine learning model to the premises device, receiving, at the control device, a detection indication corresponding to at least one additional classified object type identified in the locally-stored media file; and
performing at least one premises security action based on the at least one additional classified object type and the security configuration.

17. The method of claim 14, wherein the feedback indication comprises at least one of:
an object type label;
an accuracy indication; and
a threat level indicator.

18. The method of claim 17, wherein the method further comprises determining or modifying the security configuration based least in part based on the threat level indication associated with at least one classified object type.

19. The method of claim 14, wherein the method further comprises:
receiving, at the control device, at least one additional media file from a premises device in the premises security system;
identifying an additional dominant object in the at least one additional media file;
detecting at least one additional classified object type of the additional dominant object using the machine learning model;
receiving, at the control device, from at least one user device in the premises security system, at least one additional feedback indication associated with the at least one additional classified object type; and
further training the machine learning model based on the at least one additional feedback indication.

20. The method of claim 14, wherein the method further comprises:
causing transmission of the machine learning model to a remote server for providing on-device objection detection for at least one additional device associated with a user account of the premises security system.
